(19) United States
(12) Patent Application Publication
(10) Pub. No.: US 2020/0412713 A1
(43) Pub. Date: Dec. 31, 2020

(54) AUTHENTICATION AND AUTHORIZATION INTEGRATION SYSTEM IN HETEROGENEOUS CLOUD PLATFORM

(71) Applicant: GEMINI OPEN CLOUD COMPUTING INC., HSINCHU CITY (TW)

(72) Inventors: Cheng-Yi FANG, HSINCHU CITY (TW); Jian Liang JHENG, HSINCHU CITY (TW)

(21) Appl. No.: 16/456,437

(22) Filed: Jun. 28, 2019

(51) Int. Cl. H04L 29/06; H04L 29/08

(52) U.S. Cl. CPC H04L 63/0846; H04L 67/10; H04L 63/0884

(57) ABSTRACT

An authentication and authorization integration system with the heterogeneous cloud platforms is proposed herein. The system packs various authentication and authorization information to issue a general token to carry the session. During the statutory period of the general token, the heterogeneous cloud platforms authenticate the user through the token instead of the session authentication of platform to avoid the complexity caused by repeating authentication to integrate these heterogeneous platforms into an architecture of micro service and stateless session.

### BACKGROUND

### Field

The invention relates to the authentication and authorization of a system, and especially to a system of integrating the authentication and authorization with heterogeneous cloud platforms.

### Description of Certain Related Art

It needs to authenticate a user before granting privilege to the user i.e. authorization, multi-factor authentication, for example. For an authenticated user, the system sets the permissions and privilege of resources and/or files for the user. For example, the system allows the user to read/write a file for a member of the system but only to read for a guest. Once the user has been authenticated, the system starts a service and sets a session for the service. In the same session, it is not necessary to repeat the authentication and authorization.

However, a cloud platform comprises a lot of functions, which are implemented by multiple services to have advantages of development and maintenance for each service, i.e. the Service-Oriented Architecture (SOA) or micro-services. These services are developed under different cloud platforms in general, and these platforms use different mechanisms for authentication and authorization, for example, some people use OpenID for authentication and use OAuth for authorization. It means the services of different cloud platforms are independent for each other. However, a user does not want to repeat the authentication and authorization when using the cloud services. The user prefers to have an integrated system for the authentication and authorization.

The invention proposes a solution to the topics of (1) without revising the cloud platform (2) to integrate the authentication and authorization and (3) to communicate with the services in different cloud platforms. An integration architecture for heterogeneous cloud platforms is proposed here.

### SUMMARY OF THE INVENTION

A Token is proposed to carry the authentication information for heterogeneous cloud platforms, and the user uses the Token to access the services of these heterogeneous cloud platforms.

An expiration time is set on the Token. In the statutory period, the user is able to access the services by exchanging the authentication information of the Token to have a stateless communication between the system and these heterogeneous cloud platforms. The stateless communication make the cloud platforms have high scalability.

The heterogeneous cloud platform uses the Token to exchange the information without revising these cloud platform and re-developing the logic of authentication and/or authorization.

An authentication and authorization integration system with the heterogeneous cloud platforms comprises of a management interface, a database, a platform registration module, a tokens collector, a general Token publisher and an API authentication interface.

The management interface is configured to be an integration authentication interface for heterogeneous cloud platforms for the manager/administrator of the cloud platform. The database is used to store the authentication information of these heterogeneous cloud platforms. The platform registration module is used to access the authentication information. The tokens collector is used to collect the tokens issued by the heterogeneous cloud platforms, and the general Token publisher is used to pack these tokens into a payload and to publish the general Token. The API authentication interface is used to provide the services in RESTful protocol. When the API authentication interface receives a request, the request will be transferred to the general Token publisher and get the payload carrying the general Token back.

### BRIEF DESCRIPTION OF THE DRAWINGS

The drawings employed here are used to explain and not to limit the present application. The drawings do not mean the whole features of the present application, but some element(s) or some strep(s) is essential for the features of the present application. In some configuration, some element(s) or step(s) can be modified to reach some function according to the spirit of the present application, and that should be in the scope of the present application, i.e. more precisely, the scope of the present application is defined in the claims.

Drawings are used to explain the invention, not to set the limitation of the invention. Any of the drawings do not comprise the whole invention necessarily, and any characteristic in any drawing is not necessary for the invention. The scope should be defined in the claims.

FIG. 1 is an embodiment to schematically show the architecture of the integration system of the authentication and the authorization in the heterogeneous cloud platforms.

FIG. 2 is an embodiment of the integration system of the authentication and the authorization in the heterogeneous cloud platforms to show the activities to register the cloud platform for the administrator.

FIG. 3 is an embodiment of the integration system of the authentication and the authorization in the heterogeneous cloud platforms to show the activities to request for services for the user.

### DETAILED DESCRIPTION OF CERTAIN EMBODIMENTS

### The Theory of the Invention

The invention proposes an authentication and authorization integration system with the heterogeneous cloud platforms, and the integration system is used to receive the authentication request and to communicate with the user via API gateway or browser. After authentication is provided by user, the API gateway can get the general Token back, which integrates the authentication information of the all heterogeneous cloud platforms. The API gateway is able to access multiple services provided these cloud platforms by exchanging the general Token.

According to the above, (1) the mechanism to issue the general Token and (2) the architecture to access the cloud services are introduced below.

There are two topics to manage the general Token, one is to get the content of the general Token, and the other is to manage the encryption of the general Token. For the communication between the heterogeneous cloud platforms and the PaaS subsystem, these platforms use the same key and protocol to encrypt and decrypt the general Token. These cloud platforms can exchange the information or data through authenticating the general Token. For example, the JSON Web Token is used in the embodiments of the document. The general Token is used to carry the authentication information of these cloud platforms and to reduce the dependency of the services from these cloud platforms, i.e. decoupling the services.

A general Token is used by the heterogeneous cloud platforms and PaaS subsystem to replace the Cookie and Session, which are stored in services. It is obvious that this invention is stateless in a session, therefore the cloud platform can be extended and expanded easily to have the advantage of high utility and load balance.

[Some Embodiments of the Integration System]

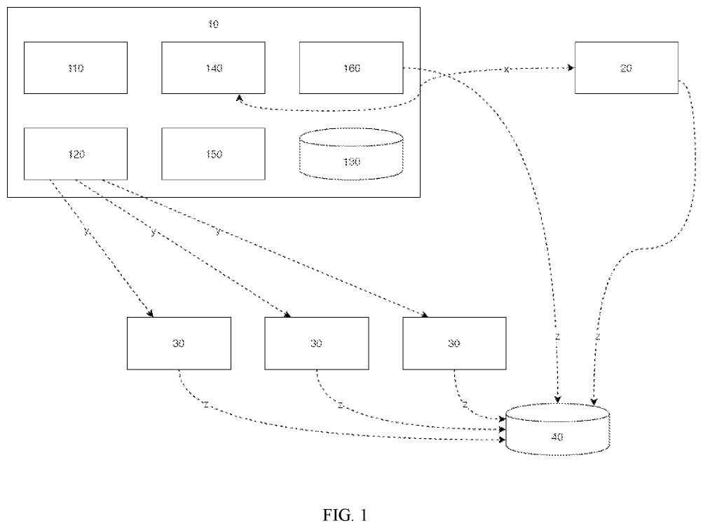

As shown as FIG. 1, the authentication and authorization integration system with the heterogeneous cloud platforms comprises of a management interface, a platform registration module, a general Token publisher, an API authentication interface, a tokens collector and a database. The integration system should be deployed in an inner network separated with the internet by the firewall.

The administrator or the manager of the cloud platform is located in the inner network to manage the resources of the cloud platform. The management interface is use by the user portal to manage the authentication information for the heterogeneous cloud platforms for the administrator or the manager of the platform. The platform registration module is used to register the information of the cloud platforms, and these information is stored in the database. The administrator or the manager of the platform or the tokens collector could retrieve the information of these cloud platforms.

A user is located in internet i.e. outside of the firewall generally, and the user access the services of the cloud platforms through the API gateway or the Web browser. The API authentication interface is configured to be the bridge to communicate between the services and the API gateway or the Web browser under the permission authorized according to the authentication.

In one embodiment of the invention, the RESTful API is used to implement the API authentication interface. The API authentication interface get the general Token back through the general Token publisher, the tokens collector and the platform registration module. The general Token publisher issues the general Token after packing and encrypting the general Token into a payload.

From an external respect, the general Token publisher and the PaaS subsystem use the same key pair to encrypt and decrypt the general Token, as shown as the dot line x. The bi-directional arrows in both end of the dot line x are used to represent that the services of the cloud platform and PaaS subsystem can be accessed via the general Token.

From an internal respect, the platform registration module is used to manage the authentication information of the heterogeneous cloud platforms, as shown as the dot line, which has an single directional arrow on one end. It means that each cloud platform keep its authentication mechanism and we can get the mechanism via the platform registration module.

The API authentication interface, the PaaS subsystem and the other heterogeneous cloud platforms could be designed to connect the same AD/LDAP server to unify the account and the password, as shown as the dot line z.

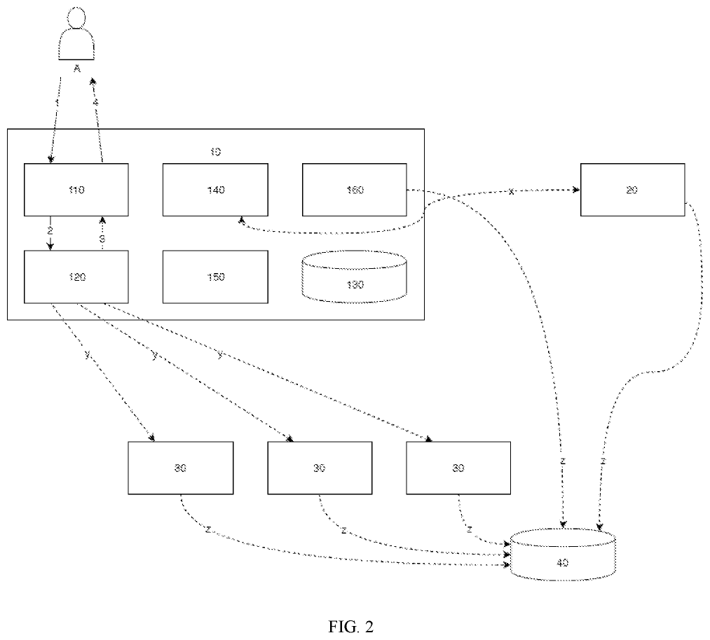

FIG. 2 is an embodiment of the invention to show the activities in a registration process with a cloud platform according to the embodiment shown in FIG. 1.

Step 1: the administrator/manager of the platform inputs the platform information, comprising the service endpoints, token endpoints and token format, and then requests for a registration via the management interface.

Step 2: The management interface transfers the platform information to the platform registration module to communicate with the cloud platforms to authenticate the authentication information. For example, the protocol of BasicAuth and AD/LDAP are used to complete the authentication. Once the authentication information passed, the authentication information will be store in the database and finish the registration process.

Step 3: The result of the authentication will transferred back and shown on the management interface.

Step 4: The administrator or the manager of platform can view all settings on the management interface.

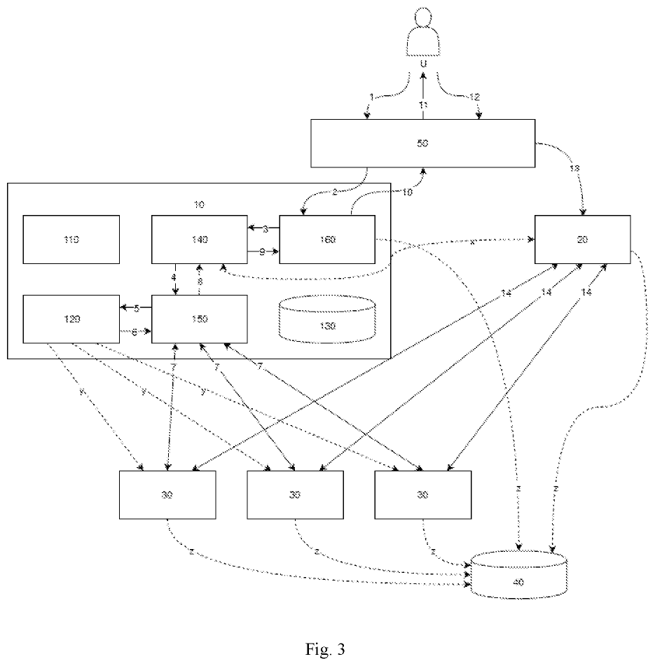

FIG. 3 is an embodiment to show the activities between components of the authentication and the authorization integration system to process the user request according to the embodiment shown in the FIG. 1.

Step 1: A user inputs his credential and then request for a general Token for heterogeneous cloud platforms through the API gateway.

Step 2: The API gateway transfer the request with the credential to the API authentication interface. First the API authentication interface authenticate the credential through the AD/LDAP and return to the API gateway if failed, i.e. not a valid user.

Step 3: If the API authenticate make sure the user is valid, the API authentication interface transfers the request to the general Token publisher to issue a general Token back.

Step 4: The general Token publisher calls the tokens collector and transfers the authentication information to the tokens collector to request the tokens of the heterogeneous cloud platforms and then to collect the authentication results.

Step 5: The tokens collector calls the platform registration module to get the platform information, including the service endpoints, token endpoints and the token format and so on.

Step 6: The platform registration module returns the platform information to the tokens collector for all cloud platforms.

Step 7: The tokens collector get the tokens back according to the registration information of these cloud platforms. It can be in parallel or in series to collect the tokens.

Step 8: The tokens collector transfers all tokens with the platform information, including the service endpoints, token endpoints and token format, from these cloud platforms to the general Token publisher.

Step 9: The general Token publisher uses a private key to encrypt the tokens and the platform information, packs them to a payload and set a statutory period, also called expiration time, for the payload to complete the publishing. Finally, the general Token is transferred to the API authentication interface to complete the process. The JSON Web Token is used in this embodiment. In general, the valid period is the shortest among the tokens collected by the tokens collector.

Step 10: The API authentication interface returns the general Token to the API gateway.

Step 11: The user retrieves the general Token via the API gateway.

Step 12: Within the statutory period, also called an expiration time, the user can use the general Token to request a service through the API gateway.

Step 13: The API gateway request the PaaS subsystem for a service.

Step 14: The PaaS subsystem uses the public key of the pair to decrypt the general Token to read the cloud platform information and the authentication information, and then request the service from the heterogeneous cloud platforms.

The embodiment used in this document are used to explain the invention, and not to limit the scope of the invention. Any uses the token to carry the platform information and the authentication information to request the services from heterogeneous cloud platforms and PaaS subsystem should be in the scope of the invention. The scope of the patent is defined in the claims not by the embodiments of the documents only.

What is claimed is:

1. An authentication and authorization integration system with the heterogeneous cloud platforms, comprising
a management interface used by a user portal for managing heterogeneous cloud platforms;
a database is used to store authentication information of the heterogeneous cloud platforms;
a platform registration module is used to retrieve the authentication information of the heterogeneous cloud platforms from the database;
a tokens collector used to collect tokens of the heterogeneous cloud platforms through the platform registration module, wherein the tokens are used to carry the authentication information and the platform information;
a general Token publisher is used to issue a general Token, including to encrypt the tokens from the tokens collector, to pack the tokens in to a payload and issue the payload; and
an API authentication interface is used to retrieve the general Token when receiving a request for services.

2. An authentication and authorization integration system with the heterogeneous cloud platforms of the claim 1, wherein the management interface is used to set a platform configuration, comprising service endpoints, token endpoints and token format.

3. An authentication and authorization integration system with the heterogeneous cloud platforms of the claim 2, wherein the platform configuration further comprises the authentication protocol, including BasicAuth OAuth and AD/LDAP.

4. An authentication and authorization integration system with the heterogeneous cloud platforms of the claim 3, wherein the API authentication interface further comprises the function to validate an user information via an AD/LDAP server.

5. An authentication and authorization integration system with the heterogeneous cloud platforms of the claim 1, wherein the general Token comprises an authentication status and an expiration time, and the authentication status can be successful or failed.

6. An authentication and authorization integration system with the heterogeneous cloud platforms of the claim 5, wherein the platform registration module is configured to record the authentication status and the management interface is configured to show the authentication status.

7. An authentication and authorization integration system with the heterogeneous cloud platforms of the claim 5, wherein the valid period of the general Token is the shortest among tokens collected by the tokens collector.
